(19) United States
(12) Patent Application Publication
(10) Pub. No.: US 2025/0286266 A1
(43) Pub. Date: Sep. 11, 2025

(54) SPEAKER MODULE, ANTENNA MODULE AND ELECTRONIC DEVICE

(71) Applicant: Wistron NeWeb Corporation, Hsinchu (TW)

(72) Inventors: Jia-Le ZHU, Hsinchu (TW); Hong-Jun JIAN, Hsinchu (TW); Chia-Hao CHANG, Hsinchu (TW)

(21) Appl. No.: 19/070,601

(22) Filed: Mar. 5, 2025

(30) Foreign Application Priority Data
Mar. 11, 2024 (TW) 113108884

(51) Int. Cl. H01Q 1/22; H01Q 9/04; H01Q 9/30

(52) U.S. Cl. CPC H01Q 1/2266; H01Q 9/0421; H01Q 9/30

(57) ABSTRACT

A speaker module includes a cavity body, a speaker element and a first antenna. The cavity body includes an outer surface, an inner surface and an accommodation space. The inner surface forms the accommodation space. The speaker element is disposed in the accommodation space. The first antenna is disposed on and extended along the outer surface.

### RELATED APPLICATIONS

This application claims the benefit of priority to Taiwan Application Number 113108884, filed on Mar. 11, 2024. The entire content of the above identified application is incorporated herein by reference.

### BACKGROUND

### Technical Field

The present disclosure relates to a speaker module, an antenna module and an electronic device, and more particularly, to a multifunction speaker module, a multifunction antenna module, and an electronic device having the speaker module and the antenna module.

### Description of Related Art

With the development trend of modern communication systems, the installation space for antenna modules in electronic devices is usually compressed, especially when the electronic device needs to meet the characteristics of multiple communication systems, multiple antennas, and multiple frequency bands. Therefore, the design of the size and position of the clearance area of the antenna module faces severe challenges.

In view of the above, there is a need to develop an antenna module and an electronic device that meet both the RF (Radio Frequency) characteristics requirements of communication systems and the space utilization rate of antenna installation.

### SUMMARY

In one aspect, the present disclosure provides a speaker module that includes a cavity body, a speaker element, and a first antenna. The cavity body includes an outer surface, an inner surface, and an accommodation space, and the inner surface forms the accommodation space. The speaker element is disposed in the accommodation space. The first antenna is disposed on and extends along the outer surface.

In another aspect, the present disclosure provides an electronic device that includes the aforementioned speaker module.

In yet another aspect, the present disclosure provides an antenna module that includes a metal element and a first antenna. The metal element has a metal surface. When observed along a first direction, a projection of a first branch of the first antenna partially overlaps with a projection of the metal element.

### BRIEF DESCRIPTION OF THE DRAWINGS

The present disclosure can be more fully understood by reading the following detailed description of the embodiment, with reference made to the accompanying drawings as follows:

FIG. 1A is a schematic diagram of an antenna module according to a first embodiment of the present disclosure.

FIG. 1B is a sectional view along line 1B-1B in FIG. 1A.

FIG. 1C is an isolation schematic diagram of the antenna module in FIG. 1A.

FIG. 2 is a schematic diagram of a speaker module according to a second embodiment of the present disclosure.

FIG. 3 is a schematic diagram of a speaker module according to a third embodiment of the present disclosure.

FIG. 4 is a schematic diagram of an electronic device according to a fourth embodiment of the present disclosure.

### DETAILED DESCRIPTION

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

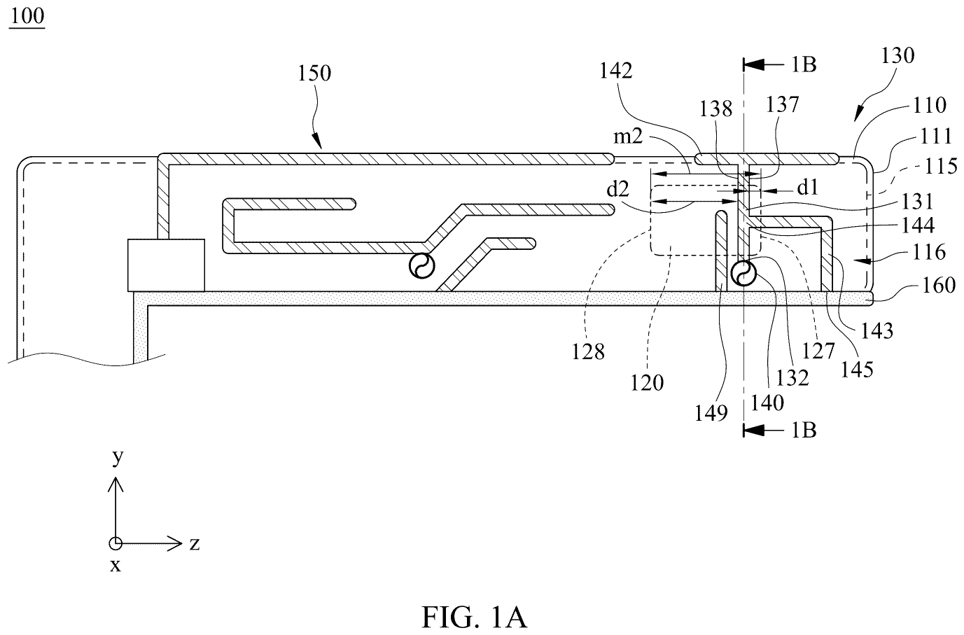

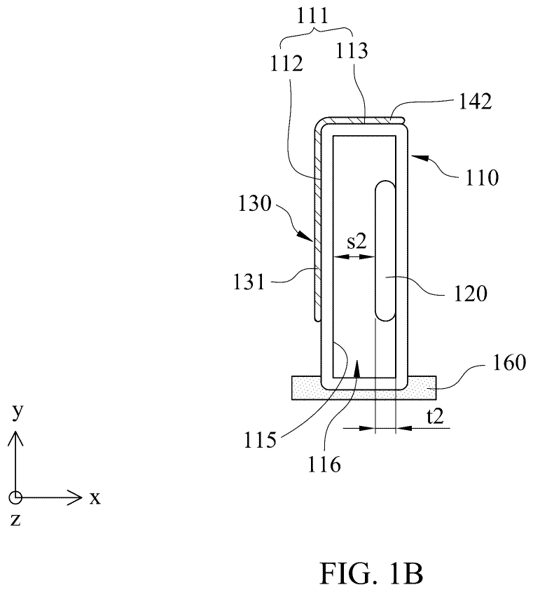

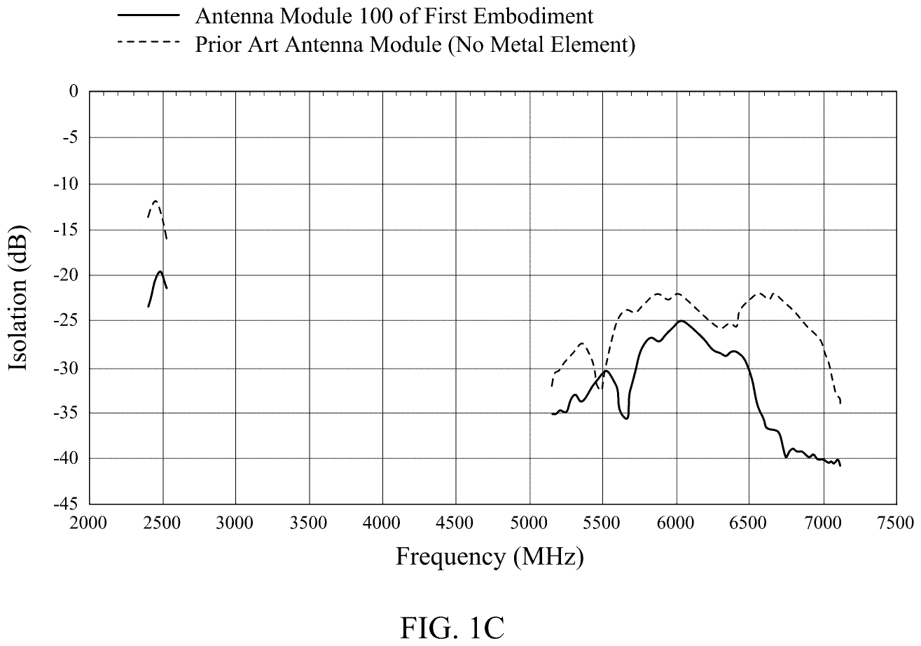

FIG. 1A is a schematic diagram of an antenna module 100 according to a first embodiment of the present disclosure. Referring to FIG. 1A, the antenna module 100 includes a metal element and a first antenna 130. The metal element has an exposed outer surface, a non-exposed inner surface, and an interposed surface, and at least one of which includes a metal (conductive) surface. The metal surface can have a floating ground characteristic or be electrically connected to a grounding element of the electronic device. The metal element can be an electronic component with circuit functions or a metal material element without circuit functions. For example, the metal element can be a speaker (transducer) element 120, and at least part of the outer surface of the speaker element 120 includes a metal surface, but the present disclosure is not limited thereto. The first antenna 130 includes a first branch 131. When observed along a first direction x, the projection of the first branch 131 partially overlaps with the projection of the speaker element 120. This helps the first antenna 130 balance RF characteristics requirements and isolate nearby circuit elements (such as the second antenna 150, but not limited thereto), thereby reducing interference between the first antenna 130 and nearby circuit elements.

Specifically, the antenna module 100 can further include a grounding element 160. One end 132 of the first branch 131 is provided with a feeding point 140 or connected to the grounding element 160. In this embodiment, one end 132 of the first branch 131 is provided with the feeding point 140. When observed along the first direction x, the projection of the one end 132 of the first branch 131 does not overlap with the projection of the speaker element 120. Particularly, the projection of the first branch 131 extends beyond the projection of the speaker element 120, placing the projections of both ends (the one end 132 and the other end) of the first branch 131 outside the projection range of the speaker element 120. Thus, when the first antenna according to the present disclosure is a PIFA (Planar Inverted-F Antenna) or a monopole antenna, the feeding point avoids the metal element or speaker element, which helps meet the requirements for RF characteristics and improves isolation.

FIG. 1B is a sectional view along line 1B-1B in FIG. 1A. Referring to FIG. 1A and FIG. 1B, the first antenna 130 can further include a second branch 142. The other end of the first branch 131 can be connected to the second branch 142. Both ends of the second branch 142 are open ends, and the second branch 142 can extend on two non-coplanar sub-surfaces 112, 113 of the outer surface 111.

The first antenna 130 can further include a grounding branch 149. One end of the grounding branch 149 is connected to the grounding element 160. When observed along the first direction x, the projection of the grounding branch 149 partially overlaps with the projection of the speaker element 120 (i.e., the projection of the grounding branch 149 and the projection of the speaker element 120 partially overlap). Thus, the second branch 142 and the grounding branch 149, in conjunction with the first branch 131 provided with the feeding point 140, make the first antenna 130 suitable for a design that enhances isolation.

Furthermore, referring to FIG. 1A and FIG. 1B, when observed along a second direction y, the projection of the second branch 142 can partially overlap with the projection of the speaker element 120. In other antenna modules according to the present disclosure (not shown), when observed along the second direction, the projection of the second branch partially overlaps with the projection of the speaker element, and when observed along the first direction, the projection of the first branch does not overlap with the projection of the speaker element.

Referring to FIG. 1A, the antenna module 100 can further include a second antenna 150. Each of the first antenna 130 and the second antenna 150 extends along the second direction y and a third direction z, i.e., each of the first antenna 130 and the second antenna 150 extends along a plane with the normal direction parallel to the first direction x. The first direction x, the second direction y, and the third direction z are perpendicular to one another. The first antenna 130, the speaker element 120, and the second antenna 150 are sequentially arranged along the third direction z. Furthermore, the operating frequency band of the first antenna 130 and the operating frequency band of the second antenna 150 can at least partially overlap. Thus, by arranging a metal element (such as the speaker element 120) with a metal surface at an appropriate position between the first antenna 130 and the second antenna 150, interference between the first antenna 130 and the second antenna 150 can be reduced. For example, the first antenna 130 can be a WLAN antenna with an operating frequency of 2.4 GHz to 8 GHz, and the second antenna 150 can be an LTE antenna with an operating frequency of 617 MHz to 6 GHz.

Moreover, the antenna module 100 of the first embodiment can also be referred to as a speaker (transducer) module. The antenna module 100 includes a cavity body 110, the speaker (transducer) element 120, and the first antenna 130. The cavity body 110 includes an outer surface 111, an inner surface 115, and an accommodation space 116. The accommodation space 116 is formed by the inner surface 115, and the speaker element 120 is disposed in the accommodation space 116. The first antenna 130 is disposed on and extends along the outer surface 111. Thus, the first antenna 130 is designed on the outer surface 111 of the cavity body 110 of the speaker element 120, achieving the effects of saving space and providing good antenna characteristics simultaneously.

In specific, the cavity body 110 can be made of a dielectric material (such as plastic, but not limited thereto), and each of the first antenna 130 and the second antenna 150 is made of a conductive (electrically conductive) material. As such, the first antenna 130 and the second antenna 150 can be further manufactured on the cavity body 110 by Laser Direct Structuring (LDS) to enhance the application flexibility of the antenna module 100.

The second antenna 150 can be disposed on and extends along the outer surface 111, and the grounding element 160 can be connected to the outer surface 111. Thus, by arranging the speaker element 120 with a metal surface at an appropriate position between the first antenna 130 and the second antenna 150, the isolation between the first antenna 130 and the second antenna 150 is improved.

Furthermore, the grounding element 160 can extend to a part of the inner surface 115 or/and a part of the outer surface 111 corresponding to the speaker element 120. Thus, adding some metal below the speaker element 120 as part of the grounding element 160 and further enclosing the entire speaker element 120 to enhance grounding can improve the isolation between the first antenna 130 and the second antenna 150.

The grounding branch 149 is connected to the grounding element 160 and is closer to the second antenna 150 than the first branch 131 thereto. The first antenna 130 can further include a third branch 143. One end 144 of the third branch 143 is connected between the one end 132 and the other end of the first branch 131. The other end 145 of the third branch 143 can be connected to the grounding element 160 or can be an open end. In this embodiment, the other end 145 of the third branch 143 is specifically connected to the grounding element 160. Thus, the antenna module 100 according to the present disclosure is applicable when the first antenna is a PIFA antenna, and the type of the second antenna 150 is not restricted. In addition, the specific patterns of the first antenna and the second antenna according to the present disclosure are not limited to those illustrated in the drawings.

The speaker element 120 has a first speaker edge 127 and a second speaker edge 128 in the third direction z, and the first speaker edge 127 is farther from the second antenna 150 than the second speaker edge 128 therefrom. The first branch 131 extends along the second direction y. The first branch 131 has a first edge 137 and a second edge 138 in the third direction z. The distance between the first edge 137 and the first speaker edge 127 in the third direction z is the first distance d1, and the distance between the second edge 138 and the second speaker edge 128 in the third direction z is the second distance d2. The first distance d1 can be smaller than the second distance d2. Accordingly, the first branch 131 and the second antenna 150 are appropriately positioned with a large-area metal surface of the speaker element 120 in between, facilitating a balance between isolation and space utilization efficiency.

The distance between the first speaker edge 127 and the second speaker edge 128 is the length m2 of the speaker element 120. The ratio of the length m2 of the speaker element 120 to the first distance d1 can be equal to or greater than 4. Alternatively, in the third direction z, the position of the first branch 131 is set within a range extending from the first speaker edge 127 toward the second speaker edge 128, up to ¼ of the length m2 of the speaker element 120. Thus, isolation can be effectively improved.

The first antenna 130 and the second antenna 150 have the same operating frequency. The ratio of the length m2 of the speaker element 120 to the corresponding wavelength of the same operating frequency can be equal to or greater than ⅛. Thus, the speaker element 120 can be used as an isolator to effectively improve the isolation between the first antenna 130 and the second antenna 150. In the first embodiment, as shown in FIG. 1A, the length m2 of the speaker element 120 in the third direction z can be 16 mm, and its width in the second direction y can be 8 mm. The first antenna 130 and the second antenna 150 operate at the same operating frequency of 2.4 GHZ. The length m2 of the speaker element 120, being 16 mm, corresponds to ⅛ of the wavelength at 2.4 GHz, making it suitable for use as an isolator.

Referring to FIG. 1B, in the first direction x, there can be a non-zero gap s2 between the speaker element 120 and a part of the inner surface 115 opposite the first antenna 130. The ratio of the gap s2 to the thickness t2 of the speaker element 120 is between 2 and 3. Thus, it helps to improve the isolation without affecting the RF characteristics of the first antenna 130.

FIG. 1C is an isolation schematic diagram of the antenna module 100 in FIG. 1A. Referring to FIG. 1C, FIG. 1C compares isolations of the antenna module 100 and a prior art antenna module (with two antennas but no metal element), and the isolation is the S21 or S12 parameter of the two antennas. FIG. 1C shows that the antenna module 100 according to the present disclosure has better isolation (i.e., smaller S21 or S12 parameter value) at most operating frequencies compared to the prior art antenna module.

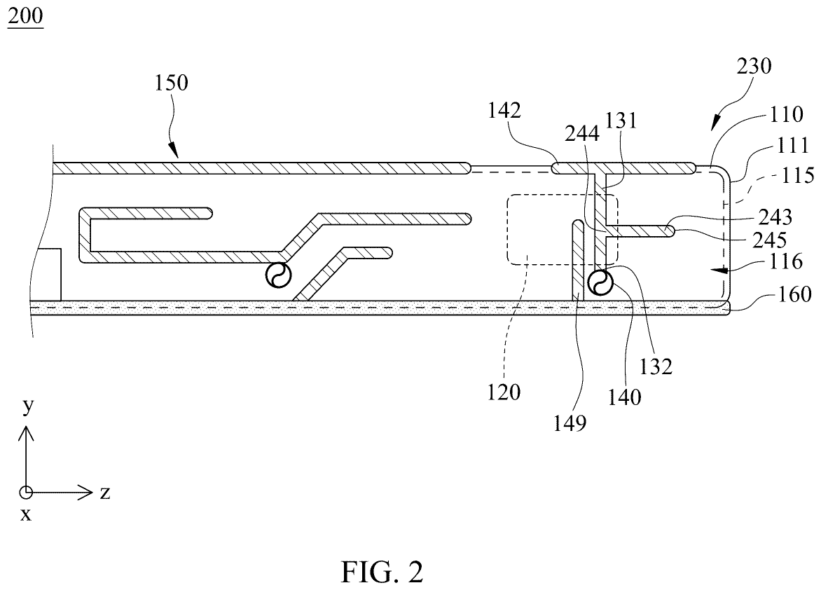

FIG. 2 is a schematic diagram of a speaker module 200 according to a second embodiment of the present disclosure. Referring to FIG. 2, the speaker module 200 of the second embodiment can also be referred to as an antenna module. The speaker module 200 includes a metal element and a first antenna 230. In specific, the metal element is the speaker element 120, which includes a metal surface. The first antenna 230 includes a first branch 131. When observed along the first direction x, the projection of the first branch 131 partially overlaps with the projection of the speaker element 120.

Furthermore, the speaker module 200 includes a cavity body 110, a speaker element 120, and a first antenna 230. The cavity body 110 includes an outer surface 111, an inner surface 115, and an accommodation space 116, and the inner surface 115 forms the accommodation space 116. The speaker element 120 is disposed in the accommodation space 116. The first antenna 230 is disposed on and extends along the outer surface 111.

The first antenna 230 further includes a third branch 243. One end 244 of the third branch 243 is connected between one end 132 and the other end of the first branch 131. The other end 245 of the third branch 243 is specifically an open end.

The main difference between the speaker module 200 of the second embodiment and the antenna module 100 of the first embodiment is that the other end 245 of the third branch 243 is an open end. Thus, the speaker module 200 according to the present disclosure is applicable when the first antenna 230 is a monopole antenna, and the type of the second antenna 150 is not restricted. Furthermore, other details of the speaker module 200 in the second embodiment can be referenced from the antenna module 100 described in the first embodiment and will not be elaborated herein. It should be noted that the length and width of the branches, as well as the parameter values of the components in the antenna module 100 and the speaker module 200, may vary depending on requirements.

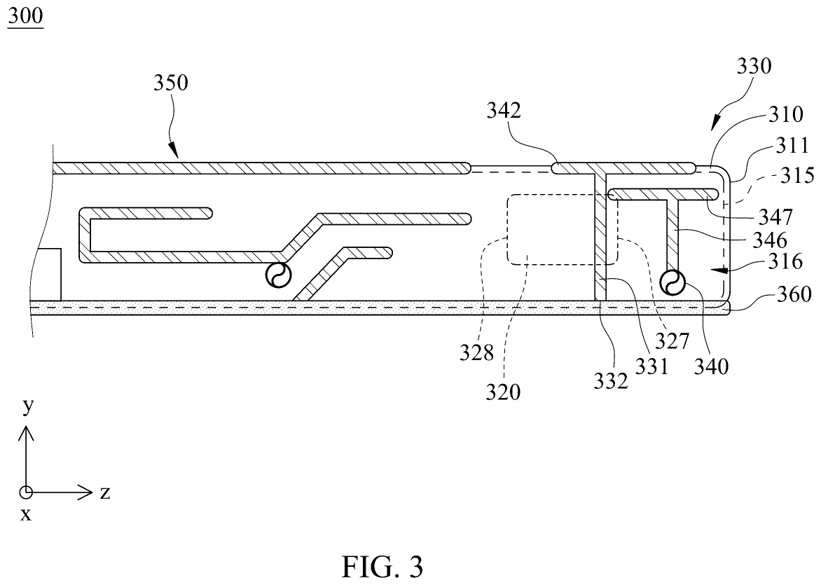

FIG. 3 is a schematic diagram of a speaker module 300 according to a third embodiment of the present disclosure. Referring to FIG. 3, the speaker module 300 of the third embodiment can also be referred to as an antenna module. The speaker module 300 includes a metal element and a first antenna 330. The metal element is specifically the speaker element 320, which includes a metal surface. The first antenna 330 includes a first branch 331. When observed along the first direction x, the projection of the first branch 331 partially overlaps with the projection of the speaker element 320.

Moreover, the speaker module 300 includes a cavity body 310, a speaker element 320, and a first antenna 330. The cavity body 310 includes an outer surface 311, an inner surface 315, and an accommodation space 316, and the inner surface 315 forms the accommodation space 316. The speaker element 320 is disposed in the accommodation space 316, and the first antenna 330 is disposed on and extends along the outer surface 311.

Specifically, the speaker module 300 further includes a grounding element 360, a second branch 342, a fourth branch 346, and a fifth branch 347. One end 332 of the first branch 331 is connected to the grounding element 360. When observed along the first direction x, the projection of one end 332 of the first branch 331 does not overlap with the projection of the speaker element 320. The other end of the first branch 331 is connected to the second branch 342, and both ends of the second branch 342 are open ends. The fourth branch 346 is farther from the second antenna 350 than the first branch 331 therefrom. One end of the fourth branch 346 is provided with a feeding point 340, and the other end of the fourth branch 346 is connected to the fifth branch 347. Both ends of the fifth branch 347 are open ends, and the fifth branch 347 is parallel to, adjacent to, and coupled with the second branch 342. Thus, the speaker module 300 according to the present disclosure is applicable when the first antenna 330 is a coupled antenna, and the type of the second antenna 350 in the speaker module 300 is not restricted. Furthermore, the fourth branch 346 serves as the feed branch, while the first branch 331 serves as the grounding branch. When observed along the first direction x, the projection of the end of the fourth branch 346 where the feed point 340 is provided does not overlap with the projection of the speaker element 320, whereas the projection of the first branch 331 partially overlaps with the projection of the speaker element 320. This arrangement helps balance RF performance requirements and enhances isolation.

Each of the first antenna 330 and the second antenna 350 extends along the second direction y and the third direction z. The first antenna 330, the speaker element 320, and the second antenna 350 are sequentially arranged along the third direction z.

The cavity body 310 is made of a dielectric material, and each of the first antenna 330 and the second antenna 350 is made of a conductive material. The second antenna 350 is disposed on and extends along the outer surface 311, and the grounding element 360 is connected to the outer surface 311. Furthermore, the grounding element 360 extends to a part of the inner surface 315 or/and a part of the outer surface 311 corresponding to the speaker element 320.

The first antenna 330 and the second antenna 350 operate at the same operating frequency. The ratio of the length of the speaker element 320 along the third direction z to the wavelength corresponding to this operating frequency is equal to or greater than ⅛, and the operating frequency bands of the first antenna 330 and the second antenna 350 may at least partially overlap. Additionally, in the third direction z, the position of the first branch 331 is set within a range extending from the first speaker edge 327 toward the second speaker edge 328, up to ¼ of the length of the speaker element 320.

In the first direction x, there is a non-zero gap between a part of the inner surface 315 opposite the first antenna 330 and the speaker element 320. The ratio of the gap to the thickness of the speaker element 320 is between 2 and 3.

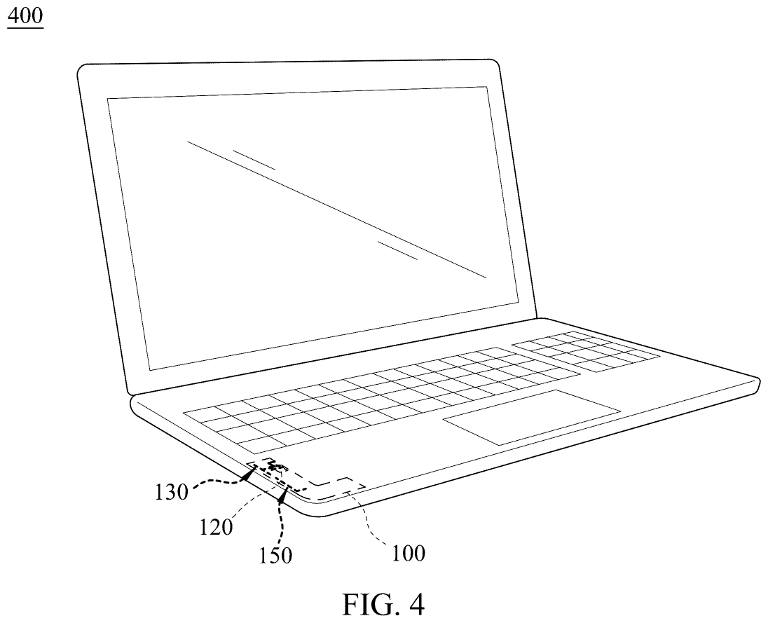

FIG. 4 is a schematic diagram of the electronic device 400 according to a fourth embodiment of the present disclosure. Referring to FIG. 1A and FIG. 4, the electronic device 400 includes the antenna module or speaker module of the present disclosure, such as the aforementioned antenna module 100, or the aforementioned speaker modules 200, 300. The electronic device 400 is specifically a notebook computer, but the present disclosure is not limited thereto. Thus, it helps to reduce interference between the first antenna 130 and the second antenna 150, and is suitable for applications in electronic devices 400 with limited space.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A speaker module comprising:
a cavity body comprising an outer surface, an inner surface, and an accommodation space, wherein the inner surface forms the accommodation space;
a speaker element disposed in the accommodation space; and
a first antenna disposed on and extending along the outer surface.

2. The speaker module according to claim 1, wherein the cavity body is made of a dielectric material, and the first antenna is made of a conductive material.

3. The speaker module according to claim 1, wherein when observed along a first direction, a projection of a first branch of the first antenna partially overlaps with a projection of the speaker element.

4. The speaker module according to claim 3, wherein in the first direction, there is a gap between the speaker element and a part of the inner surface opposite the first antenna, and a ratio of the gap to a thickness of the speaker element is between 2 and 3.

5. The speaker module according to claim 3, further comprising:
a grounding element connected to the outer surface, wherein one end of the first branch is provided with a feeding point or connected to the grounding element;
wherein, when observed along the first direction, a projection of the one end of the first branch does not overlap with the projection of the speaker element.

6. The speaker module according to claim 3, further comprising:
a second antenna disposed on and extending along the outer surface; and
a grounding element connected to the outer surface;
wherein each of the first antenna and the second antenna extends along a second direction and a third direction, the first direction, the second direction, and the third direction are perpendicular to one another, and the first antenna, the speaker element, and the second antenna are sequentially arranged along the third direction.

7. The speaker module according to claim 6, wherein the speaker element comprises a metal surface, and the grounding element extends to a part of at least one of the inner surface and the outer surface corresponding to the speaker element.

8. The speaker module according to claim 6, wherein an operating frequency band of the first antenna and an operating frequency band of the second antenna at least partially overlap.

9. The speaker module according to claim 6, wherein the speaker element has a first speaker edge and a second speaker edge in the third direction, and the first speaker edge is farther from the second antenna than the second speaker edge therefrom;
wherein the first branch extends along the second direction, the first branch has a first edge and a second edge in the third direction, a distance between the first edge and the first speaker edge in the third direction is a first distance, a distance between the second edge and the second speaker edge in the third direction is a second distance, and the first distance is smaller than the second distance.

10. The speaker module according to claim 9, wherein a distance between the first speaker edge and the second speaker edge is a length of the speaker element, and a ratio of the length of the speaker element to the first distance is equal to or greater than 4.

11. The speaker module according to claim 9, wherein a distance between the first speaker edge and the second speaker edge is a length of the speaker element, the first antenna and the second antenna have a same operating frequency, and a ratio of the length of the speaker element to a corresponding wavelength of the same operating frequency is equal to or greater than ⅛.

12. The speaker module according to claim 6, wherein one end of the first branch is provided with a feeding point, the other end of the first branch is connected to a second branch of the first antenna, and both ends of the second branch are open ends;
wherein, when observed along the first direction, a projection of a grounding branch of the first antenna partially overlaps with a projection of the speaker element, and the grounding branch is connected to the grounding element and closer to the second antenna than the first branch thereto;
wherein one end of a third branch of the first antenna is connected between the one end and the other end of the first branch, and the other end of the third branch is connected to the grounding element or is an open end.

13. The speaker module according to claim 6, wherein one end of the first branch is connected to the grounding element, the other end of the first branch is connected to a second branch of the first antenna, and both ends of the second branch are open ends;
wherein a fourth branch of the first antenna is farther from the second antenna than the first branch therefrom, one end of the fourth branch is provided with a feeding point, the other end of the fourth branch is connected to a fifth branch of the first antenna, both ends of the fifth branch are open ends, and the fifth branch is parallel to and adjacent to the second branch.

14. An electronic device, comprising:
the speaker module according to claim 1.

15. An antenna module, comprising:
a metal element comprising a metal surface; and
a first antenna;
wherein, when observed along a first direction, a projection of a first branch of the first antenna partially overlaps with a projection of the metal element.

16. The antenna module according to claim 15, further comprising:
a grounding element, wherein one end of the first branch is provided with a feeding point or connected to the grounding element;
wherein, when observed along the first direction, a projection of the one end of the first branch does not overlap with the projection of the metal element.

17. The antenna module according to claim 16, wherein the other end of the first branch is connected to a second branch of the first antenna, and both ends of the second branch are open ends.

18. The antenna module according to claim 15, wherein when observed along the first direction, a projection of a grounding branch of the first antenna partially overlaps with the projection of the metal element.

19. The antenna module according to claim 15, further comprising:
a second antenna;
wherein each of the first antenna and the second antenna extends along a second direction and a third direction, the first direction, the second direction, and the third direction are perpendicular to one another, and the first antenna, the metal element, and the second antenna are sequentially arranged along the third direction.
